(19) United States
(12) Patent Application Publication
(10) Pub. No.: US 2026/0128638 A1
(43) Pub. Date: May 7, 2026

(54) GROUNDING BRUSH ASSEMBLY

(71) Applicant: AKTIEBOLAGET SKF, GOTEBORG (SE)

(72) Inventors: Thomas PERROTIN, Saint Roch (FR); Emmanuel BENEVISE, Monts (FR); Kevin WATTIEAUX, Pernay (FR); Bruno CONSTANT, Tours (FR); Jean-Marie GERARD, Joué-Lès-Tours (FR); Benoit ARNAULT, Saint-Cyr-sur-Loire (FR)

(21) Appl. No.: 19/371,091

(22) Filed: Oct. 28, 2025

(30) Foreign Application Priority Data
Nov. 7, 2024 (FR) FR2412169

(51) Int. Cl. H02K 5/16; H02K 5/14; H02K 7/00; H02K 7/08; H02K 11/40

(52) U.S. Cl. CPC H02K 5/16; H02K 5/14; H02K 7/003; H02K 7/08; H02K 11/40

(57) ABSTRACT

A grounding brush assembly includes a grounding brush and a mounting plate for the brush, the brush being provided with a plurality of conductive fibers and with a support inside of which the conductive fibers are housed. The mounting plate is secured to the support and is provided with a radially extending main body having an axially extending centering portion and retaining tongues for axially holding the support. The assembly also includes bearing portions, formed as radial deformations of the centering portion, in order to axially hold the support.

### CROSS-REFERENCE

This application claims priority to French patent application no. 2412169 filed on Nov. 7, 2024, the contents of which are fully incorporated herein by reference.

### BACKGROUND OF THE INVENTION

The present invention relates to grounding devices for controlling the shaft current generated in electric motors or machines, and more particularly to grounding brush assemblies.

In an electric motor or machine, at least one rolling bearing is typically mounted between the housing of the electric motor or machine and the rotary shaft in order to support the shaft and rotatably couple it with the housing.

In operation when the shaft is rotating, a difference in electrical potential can be generated between the shaft and the housing of the electric motor or machine, which may thereby generate an electric current between the inner race of the rolling bearing, which is secured to the shaft, and the outer race secured to the housing.

The electric current passing through the components of the rolling bearing may damage these components, in particular the rolling elements and the raceways formed on the inner and outer races. Electrical discharges may also generate vibrations.

In order to remedy these drawbacks, it is a known practice to earth or ground the rotary shaft by using a grounding brush comprising conductive fibers. The grounding brush is generally mounted in the bore of the housing of the electric motor in such a way that the free ends of the fibers are in radial contact with the outer surface of the rotary shaft.

Due to the conductivity of these fibers, the brush is kept at the same electrical potential as the housing of the electric motor. The inner and outer races of the rolling bearing are also at the same electrical potential, which reduces or even eliminates problematic electrical discharges through the rolling bearing.

US Patent Publication No. 2021/0021180A1 discloses a grounding brush assembly comprising a grounding brush provided with a support and with a plurality of conductive fibers mounted in this support, and an annular mounting plate provided with a plurality of tongues for radially and axially retaining the grounding brush support and with an annular outer flange radially surrounding the brush and the tongues. The tongues are typically formed by plastic deformation of the mounting plate.

Such a grounding brush assembly has a relatively large radial dimension. For electric motor applications of reduced radial compactness, it would not be possible to install such an assembly.

### SUMMARY OF THE INVENTION

The present invention aims to remedy the above-noted drawback, and relates to a grounding brush assembly for an electric motor provided with a rotating shaft, a fixed housing and a bearing.

The grounding brush assembly comprises a grounding brush provided with a plurality of conductive fibers and with a support inside which the conductive fibers are mounted. The assembly also comprises a brush mounting plate which is secured to the support of the brush.

The mounting plate includes: a main body formed by a radial portion, the brush support being in axial abutment against the main body; and a centering portion at least axially extending the main body, extending axially on the same side as the brush support, offset radially outwards with respect to the support, and provided with an outer surface defining the outer diameter of the mounting plate in order to center the mounting plate after mounting in a bore of the housing of an associated electric motor.

According to a general feature of the present invention, the mounting plate includes a plurality of retaining tongues engaged with the brush support and a plurality of bearing portions for the support.

According to the present invention, the retaining tongues extend radially toward the inside of the assembly from the centering portion. Each retaining tongue comes into axial abutment against the brush support on the axially opposite side from the main body, the support thus being retained axially by the main body on one side and by the retaining tongues on the other side.

The bearing portions consist of radial deformations extending from the centering portion, radially towards the inside of the assembly. The bearing portions come into radial abutment on an upper axial surface of the brush support.

In one embodiment, the centering portion may be annular. Alternatively, the centering portion may comprise a plurality of axial portions spaced apart from one another in the circumferential direction.

In one embodiment, the retaining tongues and the bearing portions are distributed alternately in the circumferential direction.

According to one embodiment, the bearing portions consist of local radial deformations, each formed over an angular sector of less than or equal to 5°, and preferably of less than or equal to 1°.

According to an alternative embodiment, the bearing portions consist of radial deformations extended in the circumferential direction, each formed over an angular sector of between 5° and 40°, and preferably of between 15° and 30°.

The present invention also relates to an electric machine or motor comprising a housing, a shaft, and a grounding brush assembly as defined above mounted at least partially radially between the housing and the shaft, the conductive fibers of the assembly being in contact with the shaft.

### BRIEF DESCRIPTION OF THE SEVERAL VIEWS OF THE DRAWINGS

The present invention will be better understood on studying the detailed description of embodiments, given by way of non-limiting example and illustrated by the appended drawings, in which:

FIG. 1 is a view in axial section of a grounding brush assembly mounted radially in part between a rotary shaft and a housing of an electric motor according to a first exemplary embodiment of the invention;

FIG. 2 is a perspective view of the grounding brush assembly in FIG. 1;

FIG. 3 is a front view of the grounding brush assembly in FIG. 1;

FIG. 4 is a view in section of the assembly in FIG. 3 along line I-I;

FIG. 5 is a view in section of the assembly in FIG. 3 along line II-II;

FIG. 6 is a view in section of the assembly in FIG. 3 along line III-III;

FIG. 7 is a front view of an alternative construction of the first embodiment grounding brush assembly, shown with a centering portion formed as a plurality of axial portions; and

FIG. 8 is a view in axial section of a grounding brush assembly mounted radially in part between a rotary shaft and a housing of an electric motor according to a second exemplary embodiment of the invention.

### DETAILED DESCRIPTION OF THE INVENTION

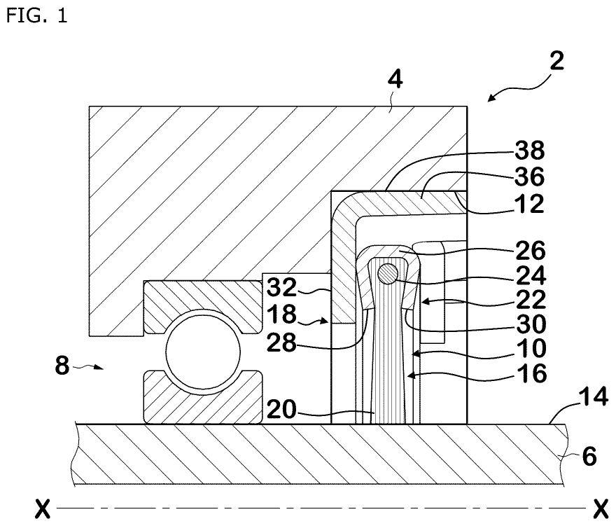

FIG. 1 shows, in axial section, a part of an electric motor or machine 2 comprising a fixed housing 4, a rotary shaft 6 rotatable about an axis X-X, which is supported radially by a bearing 8. Preferably, the bearing 8 is a ball bearing of the ball type, but may alternatively a rolling bearing with any other type of rolling elements, such as for example, cylindrical rollers, tapered rollers, needles, etc. and may even be formed a plain bearing (i.e., without rolling elements).

The motor 2 further comprises a grounding brush assembly 10 which is mounted at least partially radially between the bore 12 of the housing 4 and the outer cylindrical surface 14 of the shaft 6. The assembly 10 is, for example, force-fit into the bore 12 of the housing 4.

In the remainder of the description, the adjectives “axial” and “radial” and the adverbs “axially” and “radially” are defined with respect to the central axis X. Thus, an axial portion or part is parallel to the axis X, whereas a radial part or portion is perpendicular to this axis and surrounds the axis X. In addition, a radial portion is provided with an “inner” surface oriented toward the axis X and with an “outer” surface oriented away from the axis X.

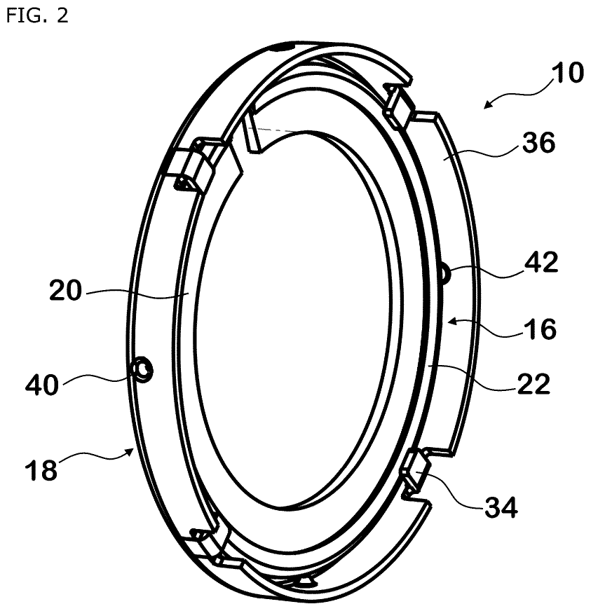

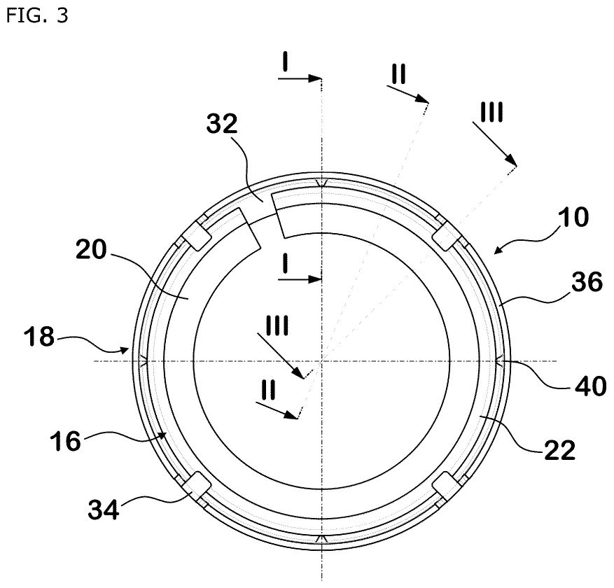

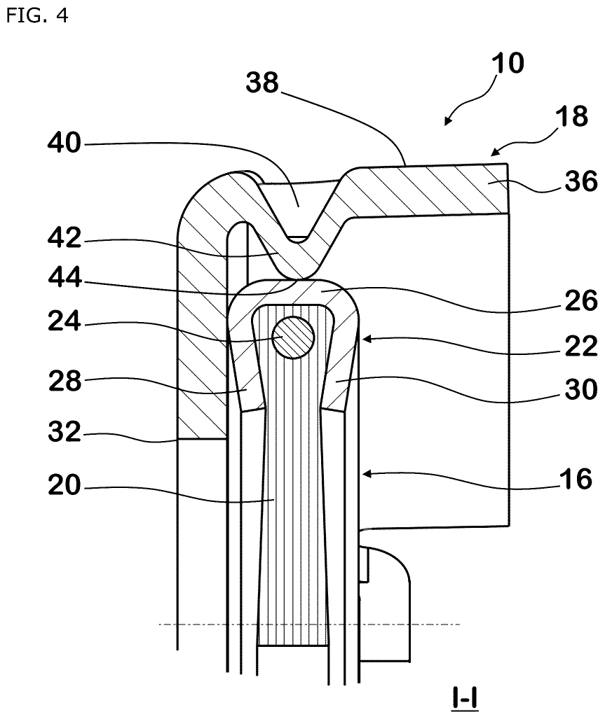

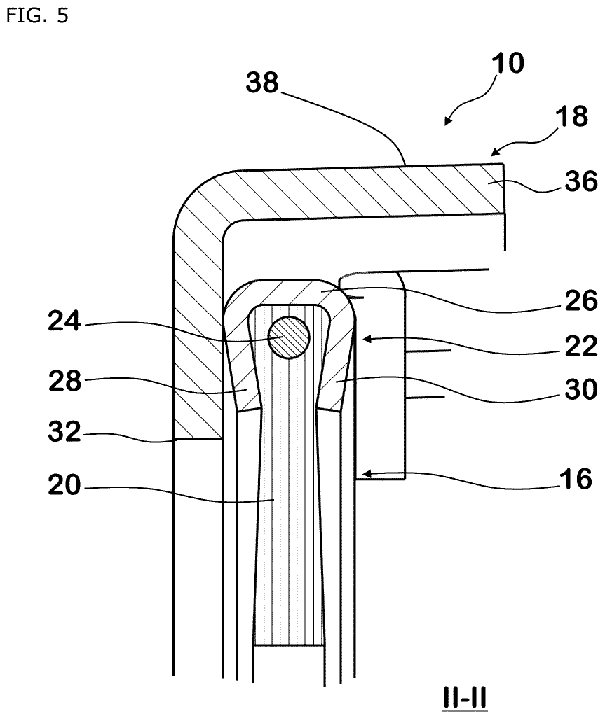

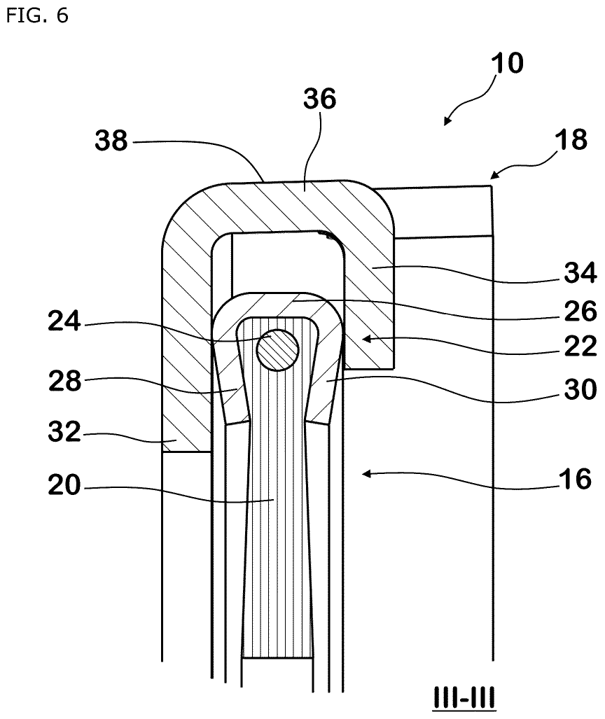

As best shown in FIGS. 2 to 6, the grounding brush assembly 10 has a generally annular shape. The assembly 10 basically comprises a grounding brush 16 and a mounting plate 18 for the brush 16.

The grounding brush 16 includes an annular support 22 and a plurality of conductive fibers 20 disposed at least partially within and extending radially from the support 22. The conductive fibers 20 may, for example, be produced from carbon, stainless steel, conductive plastics, such as acrylic fibers or fibers made of nylon. Preferably, the plurality of conductive fibers 20 are distributed circumferentially within the annular support 22 so as to form of an open ring. In the illustrated example, the conductive fibers 20 are bent around a connecting wire 24. The distal free ends of the conductive fibers 20 are intended to come into radial contact with the outer surface 14 of the shaft 6.

In order to ensure the mounting and the retention of the conductive fibers 20, the support 22 comprises a cylindrical portion 26 defining an upper axial surface for the support 22, a first lateral edge 28 extending radially from one axial end of the cylindrical portion 26 and a second lateral edge 30 extending radially from another axial end of the cylindrical portion 26. The first edge 28 is positioned axially toward the outside of the assembly 10, whereas the second edge 30 is positioned axially toward the bearing 8, the edges 28, 30 being axially opposite with respect to the cylindrical portion 26 and the fibers 20.

The mounting plate 18 is secured to the support 22. The mounting plate 18 includes a main body 32 formed by a radial portion, which is in axial abutment against the first edge 28 of the support 22, and an axial centering portion 36.

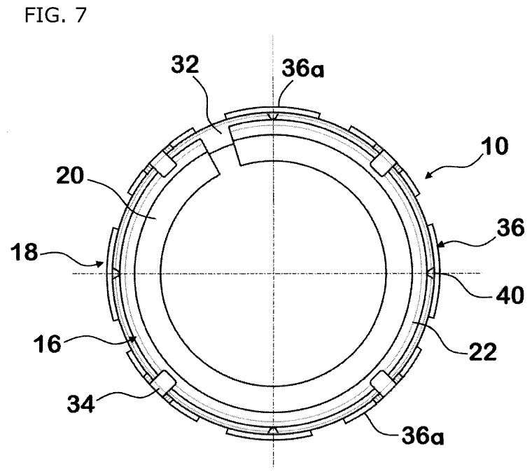

The centering portion 36 of the mounting plate 18 extends axially from the main body 32, in a direction away from the bearing 8. According to the embodiment illustrated in FIGS. 1 to 6, the centering portion 36 consists of an annular cylindrical portion. As a variant, the centering portion 36 may include a plurality of axial portions 36a spaced apart from each other in the circumferential direction, as depicted in FIG. 7.

The centering portion 36 has an outer surface 38 defining the outer diameter of the mounting plate 18 in order to center the mounting plate 18 after mounting the grounding brush assembly 10 within the bore 12 of the housing 4 of the associated electric motor 2. The centering portion 36 is preferably force-fit within the bore 12 of the housing 4 in order to create a diametral interference for ensuring the mechanical retention of the mounting plate 18 in the housing 4.

According to the invention, the mounting plate 18 includes a plurality of retaining tongues 34 for axially retaining the brush 16.

Each retaining tongue 34 extend radially inwardly from the centering portion 36 of the mounting plate 18. The tongues 34 each consist of an essentially radial portion bent inwards from the axial centering portion 36. The tongues 34 are circumferentially spaced apart from each other.

Each retaining tongue 34 extends from the centering portion 36 of the mounting plate 18 such that the retaining tongue 34 axially contacts the second lateral edge 30 of the brush support 22. On the axially opposite side, the first lateral edge 28 of the support 22 is held axially bearing against the radial main body 32 of the mounting plate 18 by the tongues 34. The brush support 22 is thus held axially by the retaining tongues 34.

In the example shown, the mounting plate 18 includes four retaining tongues 34 spaced apart regularly or evenly in the circumferential direction. As a variant, the mounting plate 18 may include any other desired number of retaining tongues 34.

The centering portion 36 extends axially from the main body 32 on the same axial side of the main body 32 as the brush support 22 held by the tongues 34, and is offset radially outwardly with respect to the support 22.

The cylindrical portion 26 of the support 22 is radially spaced apart from the centering portion 36, and the second lateral edge 30 is in axial contact against the tongues 34. The cylindrical portion 26 of the brush support 22 extends axially from the large-diameter end of the first lateral edge 28.

The second lateral edge 30 of the support 22 extends radially inwardly from the cylindrical portion 26. The second lateral edge 30 extends from the cylindrical portion 26 on the opposite side from the first lateral edge 28. The cylindrical portion 26 and the first and second lateral edges 28, 30 are each of annular shape and delimit a channel which is radially open on the inside and inside which one end of the conductive fibers 20 is positioned. The first and second lateral edges 28, 30 axially clamp the conductive fibers 20. The conductive fibers 20 are in axial abutment on each side against the first and second lateral edges 28, 30.

In the illustrated exemplary embodiment, the conductive fibers 20 radial abut against the cylindrical portion 26 and the first and second lateral edges 28, 30 extend obliquely inwardly from the cylindrical portion 26 to clamp against the fibers 20. As a variant, the first and second lateral edges 28, 30 could extend entirely radially.

The mounting plate 18 and the grounding brush 16 comprise an electrically conductive material, such as for example, aluminum, stainless steel, bronze, copper, a conductive polymer or any other appropriate material.

According to another aspect of the invention, the mounting plate 18 further includes a plurality of bearing portions 40 for axially holding the brush support 22.

According to the first embodiment of the invention illustrated in FIGS. 2 to 6, the bearing portions 40 consist of localized radial deformations extending radially inwardly from the centering portion 36 toward a geometric center of the assembly 10.

The bearing portions 40 are each formed over an angular sector of less than or equal to 5°, i.e., no greater than 5°, and preferably of less than or equal to 1° or no greater than 1°.

In the illustrated example, the bearing portions or deformations 40 are of essentially conical shape, with an inner wall 42 inclined toward the inside of the assembly 10. According to other variants that are not illustrated, the bearing portions 40 may have other shapes such as spheres, cylinders, parallelepipeds, etc. without departing from the scope of the present invention. In practice, the deformations 40 may be produced, for example, by forming or pressing in a stamping operation. The material of the centering portion 36 is deformed radially inwardly by a punch exerting a radial force from the upper surface 38 of the centering portion 36.

Each of the bearing portions 40 radially abuts on an upper axial surface of the cylindrical portion 26 of the brush support 22. More specifically, the inclined inner wall 42 of each bearing portion 40 has a bearing surface 44 in direct radial contact with the cylindrical surface 26.

The support 22 is thus held radially in position by the plurality of bearing surfaces 44 in direct contact with the outer surface of the cylindrical portion 26 of the support 22. This radial retention of the support 22 is in combination with the axial retention between the tongues 34 and the main body 32, ensuring the support 22 is held in position with the mounting plate 18. Since the mounting plate 18 is itself fit within a bore 12 of the housing 4, the fibers 20 mounted in the support 22 are thus positioned with respect to the bearing 8, the housing 4, and the rotating shaft 6 in order to ensure conductive path(es) for the passage of electric current.

In the example shown, the mounting plate 18 includes four bearing portions 40 spaced apart regularly or evenly in the circumferential direction. Alternatively, the mounting plate 18 may include any other desired number of bearing portions 40.

In the example shown, the retaining tongues 34 and the bearing portions 40 are distributed alternately in the circumferential direction. As a variant, the tongues 34 and the bearing portions 40 may be arranged in any other desired manner, for example, two or more bearing portions 40 being located between two circumferentially successive tongues 34, or two or more tongues 34 arranged between two successive bearing portions 40.

Due to the structure of the present invention, the grounding brush assembly 10 may have a reduced radial compactness compared with prior art grounding brush assemblies, for example as disclosed in US Patent Publication No. 2021/0021180 A1.

Furthermore, the bearing portions 40 also increase the rigidity of the mounting plate 18. The centering portion 36 is force-fit within the housing 4, and the risk of deformation of the centering portion 36, of the main body 32, or of a connection portion between the centering portion 36 and the main body 32 is generally relatively high. However, by providing the deformations or bearing portions 40 with inclined walls 42 serves to stiffen the assembly 10 and reduce the risk of deformation.

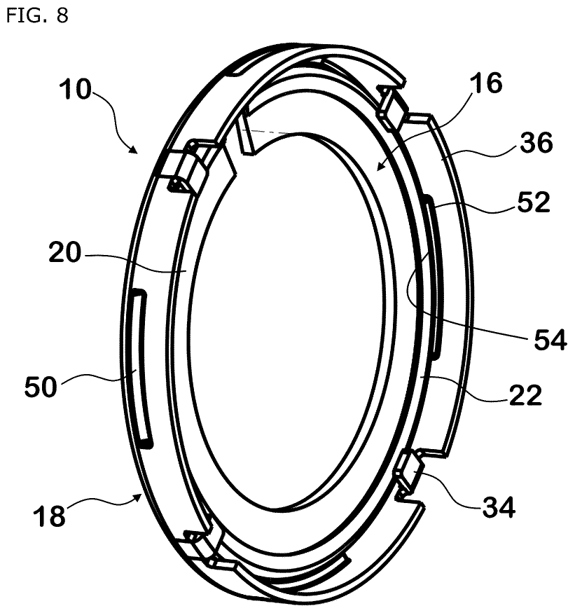

A second embodiment of the invention is illustrated in FIG. 8, which differs from the first embodiment in terms of the dimensions or sizing of the bearing portions.

Specifically, the mounting plate 18 comprises a plurality of bearing portions 50 for axially holding the brush support 22. The bearing portions 50 consist of extended radial deformations extending radially inwardly from the centering portion 36 toward the center of the assembly 10.

The bearing portions 50 are each formed over an angular sector about equal to 20° in the depicted example. The angular sector of each bearing portion 50 could be lesser or greater than 20°, for example between 5° and 40°.

The deformations or bearing portions 50 each have inner walls 52 inclined toward the inside of the assembly 10. Each bearing portions 50 radially abuts on an upper axial surface of the cylindrical portion 26 of the brush support 22. More specifically, the inclined inner walls 52 each have a bearing surface 54 in direct radial contact with the cylindrical surface 26 of the support 22.

Furthermore, all or only some of the technical features of the various embodiments may be combined with one another. Thus, the grounding brush assembly 10 can be adapted in terms of cost, performance and ease of use.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A grounding brush assembly for an electric motor, the motor including a shaft rotatable about an axis, a fixed housing and a bearing rotatably coupling the shaft with the housing, the grounding brush assembly comprising:
a grounding brush including a support and a plurality of conductive fibers disposed at least partially within the support; and
a brush mounting plate secured to the brush support and including a main body formed by a radial portion, the brush support being in axial abutment against the main body, a centering portion extending at least axially from the main body on a same axial side as the brush support, the centering portion being offset radially outwardly with respect to the support, provided with an outer surface defining an outer diameter of the mounting plate and configured to center the mounting plate within the bore of the housing of the motor, a plurality of retaining tongues for retaining the brush support, the tongues extending radially inwardly from the centering portion, each tongue axial abutting against the brush support on an axially opposite side from the main body such that the support is retained axially by the main body on one side and by the retaining tongues on another side, and a plurality of bearing portions each formed as a radially-inwardly extending deformation of the centering portion and coming into radial abutment on an upper axial surface of the brush support.

2. The assembly according to claim 1, wherein the centering portion is annular.

3. The assembly according to claim 1, wherein the centering portion includes a plurality of axial portions spaced circumferentially apart from each other.

4. The assembly according to claim 1, wherein the retaining tongues and the bearing portions are distributed alternately in the circumferential direction.

5. The assembly according to claim 1, wherein each bearing portion is formed as a local radial deformation of the centering portion, each bearing portion being formed over an angular sector of no greater than 5°.

6. The assembly according to claim 5, wherein each bearing portion being formed over an angular sector of no greater than 1°.

7. The assembly according to claim 1, wherein each bearing portion is formed as a radial deformation of the centering portion extending in the circumferential direction, each bearing portion being formed over an angular sector of between 5° and 40°.

8. The assembly according to claim 7, wherein each bearing portion is formed over an angular sector of between 15° and 30°.

9. An electric motor comprising:
a housing;
a shaft; and
a grounding brush assembly according to claim 1 mounted at least partially radially between the housing and the shaft, the conductive fibers of the assembly being in contact with the shaft.
